(19) United States
(12) Patent Application Publication
(10) Pub. No.: US 2022/0332227 A1
(43) Pub. Date: Oct. 20, 2022

(54) SEAT AIR-CONDITIONER

(71) Applicant: DENSO CORPORATION, Kariya-city (JP)

(72) Inventors: Naoto GOTO, Kariya-city (JP); Shuji ITO, Kariya-city (JP); Masafumi KAWASHIMA, Kariya-city (JP)

(21) Appl. No.: 17/857,392

(22) Filed: Jul. 5, 2022

Related U.S. Application Data
(63) Continuation of application No. PCT/JP2021/001268, filed on Jan. 15, 2021.

(30) Foreign Application Priority Data
Jan. 29, 2020 (JP) 2020-012813

(51) Int. Cl. B60N 2/56; B60H 1/00; B60H 1/34

(52) U.S. Cl. CPC B60N 2/5642; B60H 1/00285; B60H 1/34

(57) ABSTRACT

A seat air-conditioner is applied for a seat on which an occupant is seated. The seat air-conditioner includes a blower configured to suck air through a supporting surface of the seat that supports the occupant, and an introducing passage through which the air is introduced from the supporting surface to the blower. The seat includes a seat cushion supporting a lower body of the occupant and a seat back supporting an upper body of the occupant. The blower is disposed in the seat back such that airflow generated by the blower flows more through the seat back than through the seat cushion.

### CROSS REFERENCE TO RELATED APPLICATION

The present application is a continuation application of International Patent Application No. PCT/JP2021/001268 filed on Jan. 15, 2021, which designated the U.S. and claims the benefit of priority from Japanese Patent Application No. 2020-012813 filed on Jan. 29, 2020. The entire disclosures of all of the above applications are incorporated herein by reference.

### TECHNICAL FIELD

The present disclosure relates to a seat air-conditioner.

### BACKGROUND

A seat air-conditioner ventilates the surroundings of a seat by arranging a blower in a seat cushion and blowing air through the seat cushion. The seat air-conditioner guides a part of airflow generated by the blower to the seat back through a duct.

### SUMMARY

According to one aspect of the present disclosure, a seat air-conditioner is applied for a seat on which an occupant is seated. The seat air-conditioner includes a blower configured to suck air through a supporting surface of the seat that supports the occupant, and an introducing passage through which the air is introduced from the supporting surface to the blower. The seat includes a seat cushion supporting a lower body of the occupant and a seat back supporting an upper body of the occupant. The blower is disposed in the seat back such that airflow generated by the blower flows more through the seat back than through the seat cushion.

### BRIEF DESCRIPTION OF DRAWINGS

FIG. 1 is a schematic perspective view of a seat to which a seat air-conditioner according to the first embodiment is applied.

FIG. 2 is a schematic diagram illustrating a seat back to which the seat air-conditioner according to the first embodiment is applied.

FIG. 3 is a schematic perspective view of a back pad of the seat back according to the first embodiment.

FIG. 4 is a schematic front view of the back pad according to the first embodiment.

FIG. 5 is a diagram for explaining pressure distribution in the seat back when a dummy is seated on the seat back.

FIG. 6 is a diagram for explaining a cold spot distribution in the body.

FIG. 7 is a diagram for explaining a perspiration amount of the body.

FIG. 8 is a graph for explaining an amount of air sucked by the seat air-conditioner according to the first embodiment.

FIG. 9 is a schematic front view showing a first modification of the back pad of the first embodiment.

FIG. 10 is a schematic front view showing a second modification of the back pad of the first embodiment.

FIG. 11 is a schematic view showing a seat to which a seat air-conditioner according to the second embodiment is applied.

FIG. 12 is a diagram for explaining an introducing passage of a seat according to the second embodiment.

FIG. 13 is a graph explaining an amount of air sucked by the seat air-conditioner according to the second embodiment.

FIG. 14 is a diagram for explaining an introducing passage of a seat according to the third embodiment.

FIG. 15 is a diagram for explaining a resistance portion provided in a connecting duct.

FIG. 16 is a diagram for explaining an introducing passage of a seat according to the fourth embodiment.

FIG. 17 is a graph for explaining a ventilation resistance in the introducing passage of the seat according to the fourth embodiment.

### DESCRIPTION OF EMBODIMENTS

To begin with, examples of relevant techniques will be described.

Conventionally, in a seat air-conditioner that ventilates the surroundings of a seat by arranging a blower in a seat cushion and blowing air through the seat cushion, one that guides a part of airflow generated by the blower to the seat back through a duct is known.

By the way, that seat air-conditioner is configured to supply air to the seat back through the duct. Therefore, the airflow generated by operating the blower flows more through the seat cushion than through the seat back. In such structure, ventilation in the vicinity of a part of the seated person's body that is insensitive to cold is preferentially performed, which is inefficient. These facts were found through studies by the present inventors.

It is an objective of the present disclosure to provide a seat air-conditioner that can efficiently provide comfort to a seated person.

According to one aspect of the present disclosure, a seat air-conditioner is applied for a seat on which an occupant is seated. The seat air-conditioner includes a blower configured to suck air through a supporting surface of the seat that supports the occupant, and an introducing passage through which the air is introduced from the supporting surface to the blower. The seat includes a seat cushion supporting a lower body of the occupant and a seat back supporting an upper body of the occupant. The blower is disposed in the seat back such that airflow generated by the blower flows more through the seat back than through the seat cushion.

According to this, the ventilation capacity in the seat back that supports the upper body, which has a higher cold spot density and greater perspiration amount than the lower body, is enhanced. That is, since ventilation in the vicinity of the part of the occupant's body that is sensitive to cold is preferentially performed, it is possible to efficiently provide the occupant with comfort.

Hereinafter, embodiments of the present disclosure will be described with reference to the drawings. In the following embodiments, portions that are the same as or equivalent to those described in the preceding embodiments are denoted by the same reference numerals, and descriptions of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such combination.

### First Embodiment

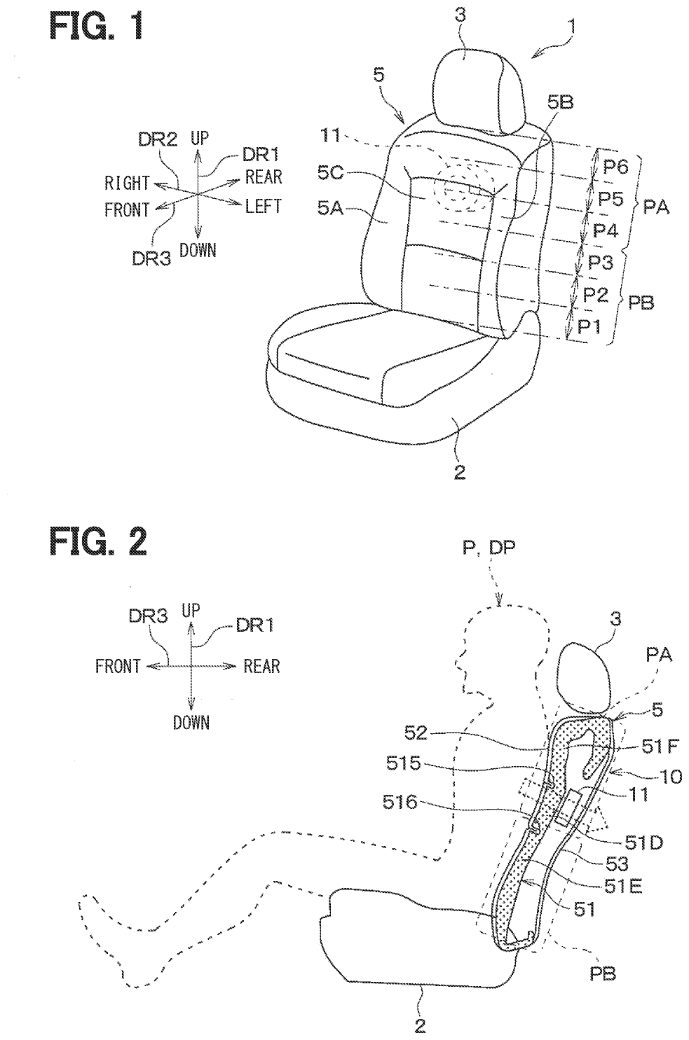

The present embodiment will be described with reference to FIGS. 1 to 8. In this embodiment, an example in which a seat air-conditioner 10 of the present disclosure is applied to a seat 1 installed in a front portion of a vehicle will be described. DR1, DR2, DR3 and the like attached to the drawings and indicating the directions are shown for easy understanding of the relationship between the drawings. Directions DR1, DR2, and DR3 indicate respectively an up-down direction, a right-left direction and a front-rear direction when the seat 1 according to this embodiment is mounted in the vehicle. The posture of the seat air-conditioner 10 of the present disclosure in the vehicle is not limited to the posture shown in the drawings.

### [Overview of Seat 1]

As shown in FIGS. 1 and 2, a seat 1 includes a seat cushion 2 on which an occupant P is seated, a headrest 3 that supports the head of the occupant P, and a seat back 5 that serves as a backrest of the occupant P. The occupant P is a user of the seat 1, and includes a person who is not actually seated on the seat 1. The occupant P shown in FIG. 2 and the like is an AM50 type dummy DP. The AM50 type dummy DP is a dummy of a 50th-percentile of an American adult male.

The seat cushion 2 is a portion that mainly supports the buttocks of the occupant P in the lower body. Although not shown, the seat cushion 2 has a cushion pad, a skin and the like. The cushion pad is a cushioning member made of an elastically deformable material such as urethane foam. The skin is a member that covers the front side of the cushion pad.

Here, the seat cushion 2 does not define an introducing passage for guiding air from the supporting surface (i.e., the front surface) of the seat 1 to a blower 11, which will be described later. That is, the seat cushion 2 has a structure such that air cannot be sucked through the seat cushion 2 by the blower which will be described later.

The headrest 3 is a portion that supports the head of the occupant P. Although not shown, the headrest 3 has a head pad, a skin and the like. The head pad is a cushioning member made of an elastically deformable material such as urethane foam. The skin is a member that covers the front side of the head pad.

The seat back 5 is a portion that supports the upper body of the occupant P except for the head. In the present embodiment, when a portion of the seat back 5 exposed to the occupant P is equally divided into an upper portion and a lower portion, the upper portion is referred to as an upper back portion PA and the lower portion is referred to as a lower back portion PB.

In the present embodiment, the portion of the seat back 5 exposed to the occupant is equally divided into six portions. The six portions are respectively referred to as a first back portion P1, a second back portion P2, a third back portion P3, a fourth back portion P4, a fifth back portion P5 and a sixth back portion P6 in order from the lower part of the seat back 5. The upper back portion PA corresponds to the fourth back portion P4, the fifth back portion P5 and the sixth back portion P6. Further, the lower back portion PB corresponds to the first back portion P1, the second back portion P2 and the third back portion P3.

Specifically, in the seat back 5, the first back portion P1 forms a supporting portion that supports the buttocks of the body, and the second back portion P2 forms a supporting portion that supports the lower back of the body. Further, the third back portion P3 and the fourth back portion P4 of the seat back 5 form a supporting portion that supports the thoracic spine of the body. Then, the fifth back portion P5 of the seat back 5 forms a supporting portion that supports the shoulders of the body, and the sixth back portion P6 of the seat back 5 forms a supporting portion that supports the cervical spine of the body. The thoracic spine of the body corresponds to a portion of the dummy DP below the shoulders and above the lower back. Further, the shoulders of the body indicate, for example, a range of the dummy DP from the clavicle to the glenohumeral joint located at the upper end of the scapula.

The lower end of the seat back 5 is connected to the rear end of the seat cushion 2 via a reclining mechanism (not shown). Further, the headrest 3 is connected to the upper end of the seat back 5. As shown in FIG. 2, the seat back 5 has a back pad 51, a skin 52, a back frame 53 and the like.

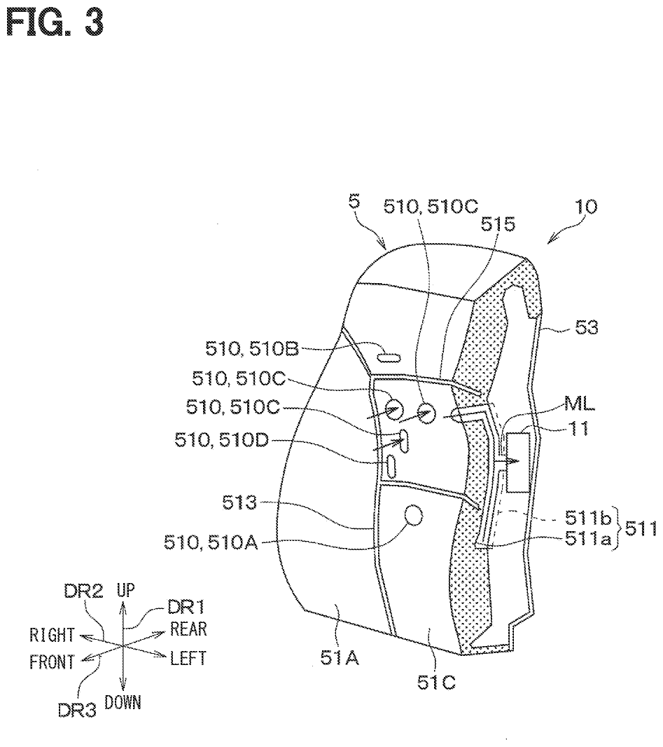

The back pad 51 is a cushioning member made of an elastically deformable material such as urethane foam. As shown in FIG. 3, the back pad 51 defines, on the front surface of the back pad 51, a plurality of ventilation holes 510 through which airflow generated by the blower 11 described later passes. The ventilation holes 510 are through holes passing through the back pad 51 between the front surface and the back surface. The positions of the plurality of ventilation holes 510 will be described later.

On the back surface of the back pad 51, a ventilation passage 511 fluidly connected to the ventilation holes 510 is defined. The ventilation passage 511 includes a ventilation groove 511a defined on the back surface of the back pad 51 and a sealing member 511b that covers the ventilation groove 511a from the back side of the back pad 51. The sealing member 511b is made of, for example, a felt.

The ventilation passage 511 is connected to a manifold ML formed on the back side of the back pad 51. The manifold ML is a space that collects the airflow flowing through the ventilation passage 511 and guides the airflow to the blower 11 which will be described later. In the present embodiment, the ventilation holes 510, the ventilation passage 511 and the manifold ML form an introducing passage through which air is introduced from the supporting surface of the seat 1 (i.e., the front surface of the seat 1) to the blower 11 which will be described later.

Here, as shown in FIG. 1, the seat back 5 has a pair of side supports 5A and 5B that support the occupant P in the width direction of the seat back 5, and a center support 5C arranged between the side supports 5A and 5B. Each of the side supports 5A and 5B protrudes more toward the occupant than the center support 5C so that the occupant can be supported in the width direction of the seat back 5.

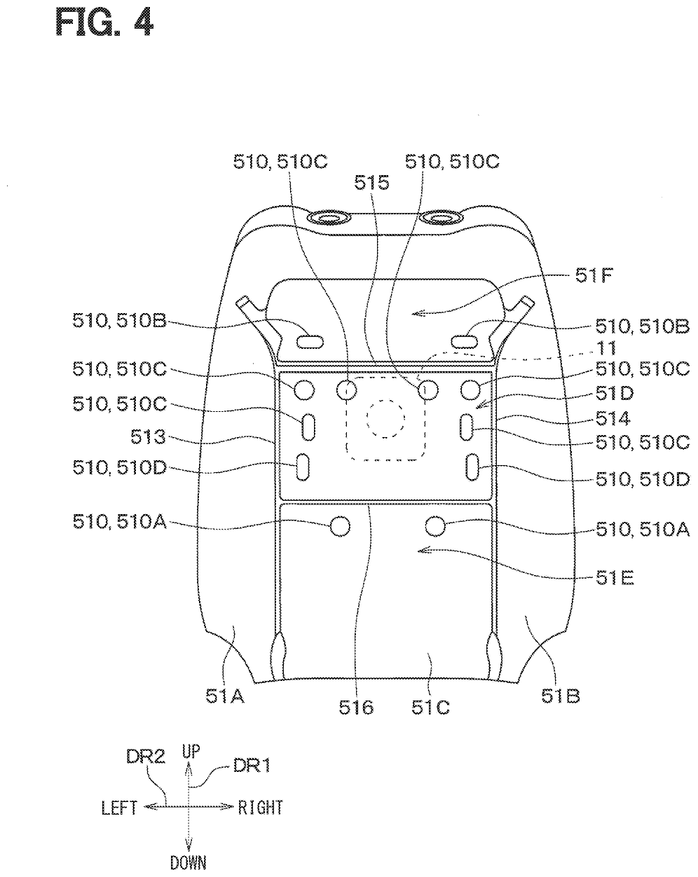

As shown in FIG. 4, the back pad 51 includes side portions 51A and 51B corresponding to the side supports 5A and 5B, and a center portion 51C corresponding to the center support 5C.

The front surface of the back pad 51 defines vertical suspension grooves 513 and 514 and horizontal suspension grooves 515 and 516 that intersect the vertical suspension grooves 513 and 514. The vertical suspension grooves 513, 514 and the horizontal suspension grooves 515, 516 are portions where the seams of the skin 52 are housed.

The vertical suspension groove 513 is formed between the side portion 51A and the center portion 51C and the vertical suspension groove 514 is formed between the center portion 51C and the side portion 51 B not to affect the sitting comfort of the seat 1. The vertical suspension grooves 513 and 514 extend from the lower end toward the upper end of the back pad 51.

The horizontal suspension groove 515 is formed at a portion corresponding to a portion below the shoulders, and the horizontal suspension groove 516 is formed at a portion corresponding to a portion above the lower back not to affect the sitting comfort of the seat 1. In other words, the horizontal suspension groove 515 is set between the second back portion P2 and the third back portion P3 of the seat back 5 and the horizontal suspension groove 516 is set between the fourth back portion P4 and the fifth back portion P5 of the seat back 5. The horizontal suspension grooves 515 and 516 extend between the vertical suspension grooves 513 and 514 to be substantially perpendicular to the vertical suspension grooves 513 and 514.

The skin 52 is a member that covers the front side of the back pad 51. Specifically, the skin 52 is arranged on the front side of the seat back 5 which is the supporting surface for the upper body of the person P. The skin 52 is made of a breathable material.

The back frame 53 is a frame-shaped member forming the skeleton of the seat back 5. The back pad 51 is attached to the back frame 53. There is a space for mounting the blower 11, which will be described later, between the back frame 53 and the back pad 51. A lumber support may be added to the back frame 53. The lumbar support holds a portion of the body near the lower back and optimizes the posture of the occupant.

(Configuration of the Seat Air-Conditioner 10)

The seat air-conditioner 10 is configured as an SVS that directly cools the human body by blowing air through the seat 1. SVS is an abbreviation for Seat Ventilation System. The seat air-conditioner 10 includes the ventilation passage 511, the blower 11 and the like that are defined in the above-described seat back 5.

The blower 11 is arranged between the back frame 53 and the back pad 51. The blower 11 is fixed to the back frame 53. Specifically, the blower 11 is provided in the upper back portion PA of the seat back 5.

The blower 11 is fluidly connected to the manifold ML. As a result, when the blower 11 is driven, airflow passes through the manifold ML. Specifically, the blower 11 has a suction port connected to the manifold ML.

In the seat air-conditioner 10, the blower 11 sucks air from the manifold ML, so that the airflow generated by the blower 11 passes through the plurality of ventilation holes 510 and the ventilation passage 511. If the seat air-conditioner 10 as described above is configured to suck air from substantially the entire front surface of the seat 1, the vicinity of the portion of the body of the occupant that is insensitive to cold is also ventilated, which is inefficient.

In contrast, the seat air-conditioner 10 of the present embodiment is configured to disproportionally suck air through the seat 1 according to a sitting pressure distribution of the back pad 51, a cold density distribution in the body of the occupant and a distribution of the perspiration amount. Specifically, the positions of the ventilation holes 510 in the back pad 51 are designed so that air is more likely to be sucked through the vicinity of a body portion of the occupant that is sensitive to cold. Hereinafter, the distribution of the sitting pressure of the back pad 51, the distribution of the cold spot density in the occupant's body, and the distribution of the perspiration amount will be described, and then the positions of the ventilation holes 510 will be described.

### [Distribution of Sitting Pressure of the Back Pad 51]

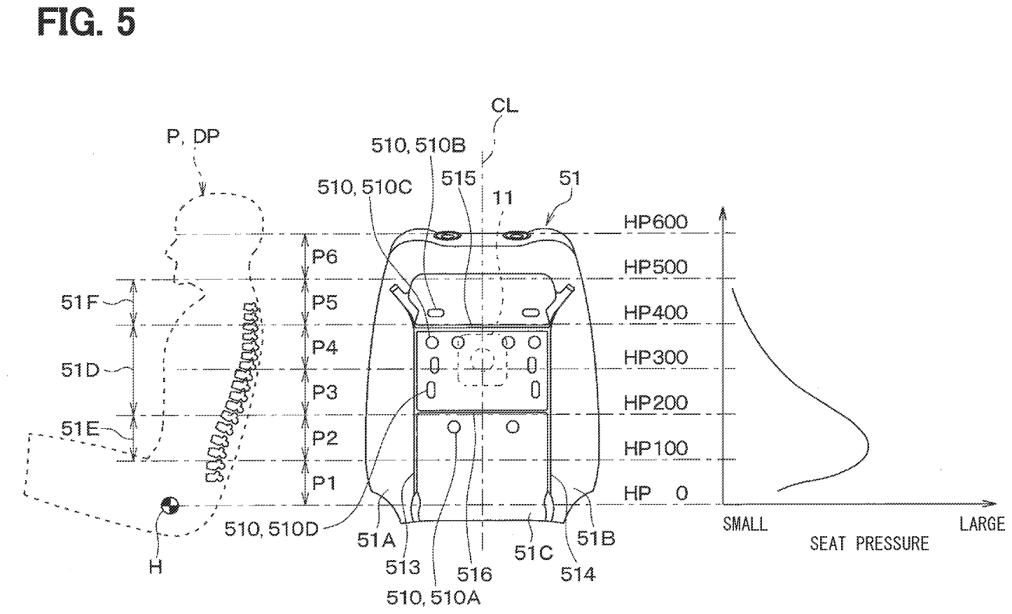

When the occupant P is seated on the seat 1 in a standard posture, the pressure acting on the portion of the seat back 5 that is exposed to the occupant P (i.e., the sitting pressure) is not uniform throughout the back pad 51. As shown in FIG. 5, the sitting pressure of the back pad 51 is maximum in the range where the distance from a hip point H of the occupant P is 100 mm to 200 mm, i.e., in the range between HP100 and HP200.

In a portion of the front surface of the back pad 51 in the range between HP100 and HP200, the occupant P and the back pad 51 are in close contact with each other, and the back pad 51 is likely to be deformed, so that airflow in the ventilation holes 510 and the ventilation passage 511 is likely to be inhibited. That is, in the lower back portion PB of the seat back 5, the airflow in the ventilation holes 510 and the ventilation passage 511 is likely to be inhibited.

On the other hand, in the range where the distance from the hip point H of the occupant P is equal to or more than 200 m, the sitting pressure of the back pad 51 decreases as the distance from the hip point H of the person P increases. That is, in the upper back portion PA of the seat back 5, the airflow in the ventilation holes 510 and the ventilation passage 511 is less likely to be inhibited. The range where the distance from the hip point H of the occupant P is within 300 mm to 600 mm corresponds to HP300 to HP600 shown in FIG. 5.

Therefore, from the viewpoint of the sitting pressure of the back pad 51, it can be expected to improve the efficiency of air conditioning by ventilating the seat back 5 except for the lower back portion PB including the range from HP100 to HP200.

Here, the number added after “HP” shown in FIG. 5 indicates the distance (unit: [mm]) from the hip point H of the occupant P. The hip point H is a reference when the occupant P is seated on the seat 1. The hip point H can be interpreted as, for example, a rotation center point connecting the torso and the thigh of the AM50 type dummy DP seated on the seat 1.

Specifically, the range between HP0 and HP100 correspond to the first back portion P1 of the seat back 5 that supports the buttocks of the body, for example. The range between HP100 and HP200 corresponds to the second back portion P2 of the seat back 5 that supports the lower back of the body, for example. The range between HP200 and HP300 corresponds to the third back portion P3 of the seat back 5 that supports the lower thoracic spine of the body, for example. The range between HP300 and HP400 corresponds to the fourth back portion P4 of the seat back 5 that supports the upper thoracic spine of the body, for example. The range between HP400 and HP500 corresponds to the fifth back portion P5 of the seat back 5 that supports the shoulders of the body, for example. The range between HP500 and HP600 corresponds to the sixth back portion P6 of the seat back 5 that supports the cervical spine of the body, for example. More specifically, the upper thoracic spine in the present embodiment is the range from the third thoracic vertebra to the seventh thoracic vertebra in the body. Further, the lower thoracic vertebra is a range from the eighth thoracic vertebra to the twelfth thoracic vertebra in the body.

### [Distribution of Cold Spot Density]

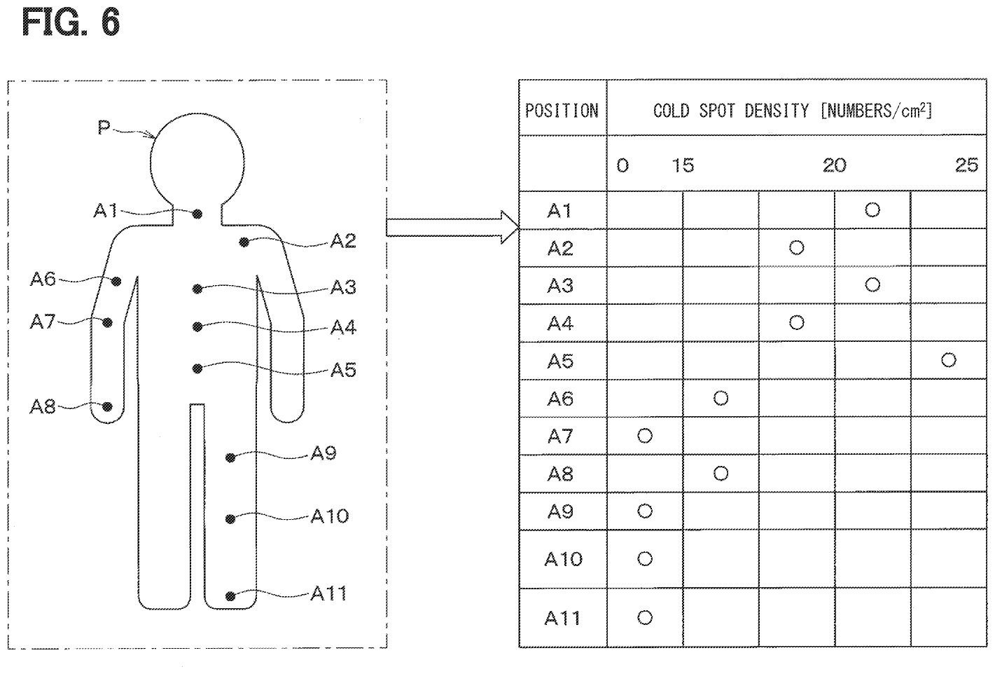

On the back surface of the body of the occupant P, cold spots sensitive to cold are not uniformly distributed, and for example, as shown in FIG. 6, there is a bias on the back surface of the body. The cold spot density is the number of cold spots per unit area.

According to FIG. 6, the cold spot density has a tendency to be large in the cervical spine A1, the shoulders A2, the upper thoracic spine A3, the lower thoracic spine A4 and the lower back A5 of the body, and to be small in the upper arms A6, the elbows A7, the hands A8, the thighs A9, the knees A10, and the legs A11.

Therefore, from the viewpoint of cold point density, it is expected to improve the efficiency of air conditioning by preferentially ventilating the cervical spine A1, the shoulder A2, the upper thoracic spine A3, the lower thoracic spine A4 and the lower back A5 of the body. In other words, from the viewpoint of the cold point density, it is expected to improve the efficiency of air conditioning by ventilating a portion within a range where the distance from the hip point H is 100 mm or more.

### [Distribution of Perspiration Amount]

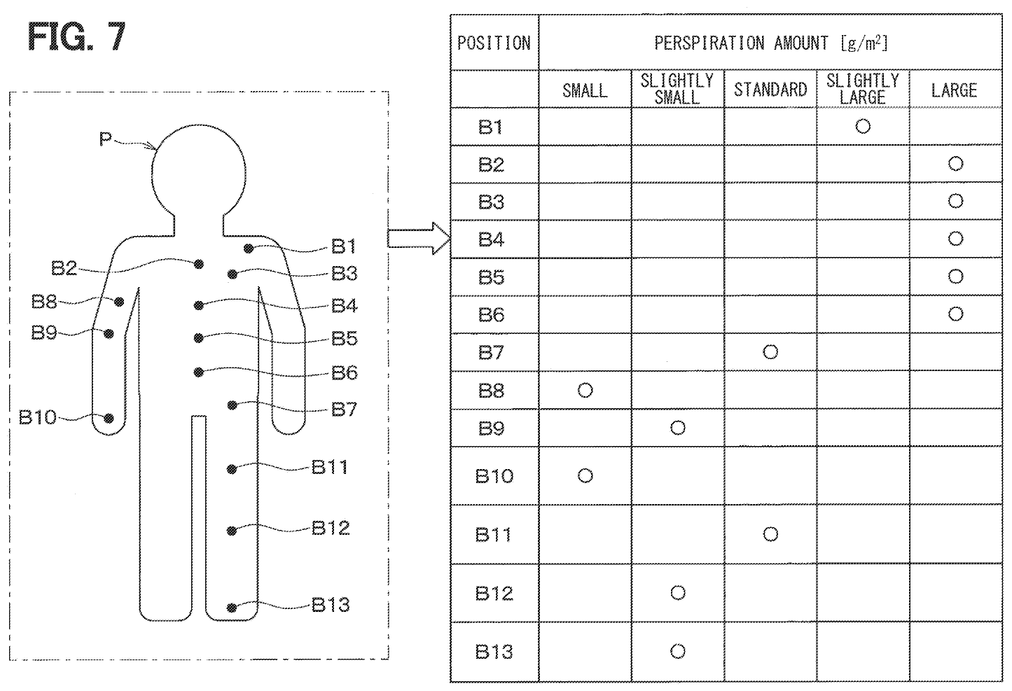

The perspiration amount is not uniformly distributed on the back of the person's body, and for example, as shown in FIG. 7, there is a bias on the back of the body. The perspiration amount is the amount of perspiration per unit area under a predetermined environmental condition.

According to FIG. 7, the perspiration amount has a tendency to be large in the upper part B1 of the shoulders, the middle part B2 of the shoulders, the lower part B3 of the shoulders, the upper thoracic spine B4, the lower thoracic spine B5 and the lower back B6, to be standard in the buttocks B7 and the thighs B11, and to be small in the upper arms B8, the elbows B9, the hands B10, the knees B12 and the legs B13.

Therefore, from the viewpoint of the perspiration amount, it is expected to improve the efficiency of air conditioning by preferentially ventilating the middle part B2 of the shoulders, the lower part B3 of the shoulders, the upper thoracic spine B4, the lower thoracic spine B5, and the lower back B6. In other words, from the viewpoint of the perspiration amount, it can be expected to improve the efficiency of air conditioning by ventilating a portion within a range where the distance from the hip point H is 100 mm or more.

### [Position of the Ventilation Holes 510]

The ventilation holes 510 of the present embodiment are disproportionally defined in the upper back portion PA in consideration of the distribution of the sitting pressure of the back pad 51, the distribution of the cold spot density, and the distribution of the perspiration amount. Specifically, the ventilation holes 510 are disproportionally defined in the range of the back pad 51 between HP300 and HP500. That is, in the back pad 51, an area occupied by the ventilation holes 510 per unit area in the shoulder corresponding portion 51F and an upper part of the thoracic spine corresponding portion 51D that correspond to the fourth back portion P4 and the fifth back portion P5 is greater than that in other areas. In the present embodiment, “the area occupied by the ventilation holes 510” means the area occupied by the ventilation holes 510 per unit area on the surface of the back pad 51.

Specifically, the back pad 51 defines two ventilation holes 510A in the lower back corresponding portion 51E that corresponds to the second back portion P2 and two ventilation holes 510B in the shoulder corresponding portion 51F that corresponds to the fifth back portion P5. Further, the back pad 51 defines, in the thoracic spine corresponding portion 51D, eight ventilation holes 510C, 510D each having substantially the same opening area with the above described ventilation hole 510A, 510B. More specifically, the back pad 51 defines six ventilation holes 510C in the fourth back portion P4 and two ventilation holes 510D in the third back portion P3. As a result, in the back pad 51, the area occupied by the ventilation holes 510 in the fourth back portion P4 is larger than the area occupied by the ventilation holes 510 in the third back portion P3.

Further, in the back pad 51, the area occupied by the ventilation holes 510 per unit area in the center portion 51C corresponding to the center support 5C is larger than the area occupied by the ventilation holes 510 in the side portions 51A and 51B corresponding to the side supports 5A and 5B. The plurality of ventilation holes 510 of the present embodiment are defined in the center portion 51C and are not defined in the side portions 51A and 51B.

Further, the plurality of ventilation holes 510 of the present embodiment are disproportionally defined in positions of the center portion 51C closer to the side portions 51A and 51B than to the central position CL of the center portion 51C. Specifically, in the back pad 51, four ventilation holes 510 are arranged along the upper horizontal suspension groove 515, and three ventilation holes 510 are arranged along each of the vertical suspension grooves 513 and 514. The ventilation passage 511 defined on the back suface of the back pad 51 is also disproportionally defined in the upper back portion PA than in the lower back portion PB to correspond to the plurality of ventilation holes 510.

(Operation of the Seat Air-Conditioner 10)

In the seat air-conditioner 10 configured in this way, when the blower 11 is driven, air is sucked through the manifold ML as shown in FIGS. 2 and 3. As a result, the air on the front side of the seat back 5 is collected in the manifold ML through the plurality of ventilation holes 510 and the ventilation passage 511, and then sucked into the blower 11 and discharged out of the seat back 5.

In this way, when air is sucked through the front side of the seat back 5, the heat of the seat back 5 which is hot at the initial stage when the occupant gets in the vehicle cannot be blown to the body of the occupant, so that the cooling effect of the body can be improved. In addition, when cold air is blown from the instrument panel at the front of the vehicle, the cold air is sucked along the body of the occupant, so that the cooling effect of the body of the occupant can be further improved.

Here, the seat air-conditioner 10 is provided in the seat back 5 so that the airflow generated by the blower 11 flows more through the seat back 5 than through the seat cushion 2. In the seat air-conditioner 10, the introducing passage for guiding air from the supporting surface of the seat 1 to the blower 11 is defined in the seat back 5 and is not defined in the seat cushion 2.

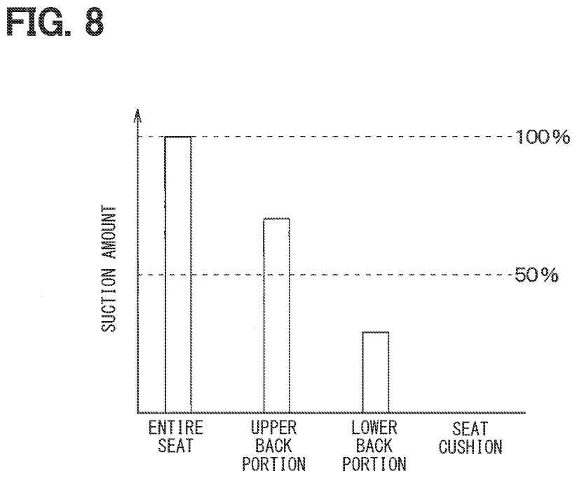

As a result, as shown in FIG. 8, the ratio of the amount of air sucked through the seat back 5 to the total amount of air sucked into the seat 1 is 100%.

In the present embodiment, the amount of air sucked into the seat 1 decreases in the order of the upper back portion PA, the lower back portion PB, and the seat cushion 2. Specifically, the ratio of the amount of air sucked through the upper back portion PA to the total amount of air sucked into the seat 1 exceeds 50%.

As described above, the seat air-conditioner 10 is provided in the seat back 5 such that an amount of the airflow generated by the blower 11 decreases in a direction from the seat back 5 toward the seat cushion 2. Specifically, in the seat air-conditioner 10, the introducing passage for guiding air from the supporting surface of the seat 1 to the blower 11 is defined in the seat back 5 and is not defined in the seat cushion 2.

According to this, the ventilation capacity in the seat back 5 that supports the upper body having a higher cold spot density and greater perspiration amount than the lower body is enhanced. That is, since ventilation in the vicinity of the part of the occupant's body that is sensitive to cold is preferentially performed, it is possible to efficiently provide the occupant with comfort.

Further, the introducing passage of the seat 1 is configured so that the ratio of the amount of air sucked through the seat back 5 to the total amount of air sucked into the seat 1 exceeds 50%. According to this, due to the structure of the introducing passage, the ventilation of the vicinity of the body portion of the occupant that is sensitive to cold is preferentially performed.

Further, the introducing passage of the seat 1 is configured so that the amount of air sucked into the seat 1 decreases in the order of the upper back portion PA, the lower back portion PB, and the seat cushion 2. According to this, the ventilation capacity in the upper back portion PA of the seat back 5 that corresponds to the shoulders and the thoracic spine where the cold spot density is high and the perspiration amount is large can be enhanced.

In particular, although the lower back portion PB of the seat back 5 corresponds to the lower back where the cold spot density is high and perspiration amount is large as in the shoulders and thoracic spine, the upper back portion PA has a lower sitting pressure in the seat back 5 than the lower back portion PB and airflow is less likely to be inhibited in the upper pack portion PA than the lower back portion PB. Thus, the occupant can be provided with comfort efficiently.

In addition, the upper back portion PA is closer to the head than the lower back portion PB. Thus, by defining the ventilation holes 510 mainly in the upper back portion PA, indirect airflow is likely to occur near the face including the forehead, cheeks, and chin where many cold spots are distributed. Thus, cool feeling can be effectively provided with the occupant P.

Further, when the ventilation passage 511 is disproportionally defined in a part of the back pad 51, it is not necessary to increase the thickness of the entire back pad 51 to define the ventilation passage 511. Thus, the weight of the back pad 51 can be reduced.

Further, the introducing passage of the seat 1 is configured such that the ratio of the amount of air sucked through the upper back portion PA to the total amount of air sucked into the seat 1 is 50% or more. According to this, the ventilation in the vicinity of the portion of the body of the occupant that is sensitive to cold and where airflow is less likely to be inhibited can be preferentially performed.

In addition, the blower 11 is provided in the upper back portion PA of the seat back 5. As described above, when the blower 11 is provided in the upper back portion PA having a large suction amount, the ventilation passage 511 of the introducing passage that is between the upper pack portion PA and the blower 11 can be shortened. Therefore, it is possible to realize efficient air conditioning in which the pressure loss in the ventilation passage 511 is suppressed and the energy loss is suppressed.

Further, when the blower 11 is provided in the upper back portion PA, the thickness of the lower back portion PB between the front side and the back side can be reduced. Therefore, a space on a lower rear side of the seat 1 is expanded, so that a space for legs of an occupant seated on the rear seat and for luggage can be sufficiently secured.

Here, the number of the plurality of ventilation holes 510 of the present embodiment is large in the portion near the side portions 51A and 51B than that in the central portion CL of the center portion 51C. In the center portion 51C, the sitting pressure is lower at the portion of the seat back 5 near the side portions 51A and 51B than at the central portion CL of the center portion 51C. Thus, airflow is less likely to be inhibited in the portion near the side portions 51A and 51B than the central portion CL of the center portion 51C. Therefore, by concentrating the positions of the plurality of ventilation holes 510 on the portion near the side portions 51A and 51B of the center portion 51C, it is possible to realize efficient air conditioning with reduced energy loss.

Further, by concentrating the positions of the plurality of ventilation holes 510 on the portion near the side portions 51A and 51B of the center portion 51C, airflow is likely to occur near the armpit where sweat glands are concentrated, so that further comfort can be provided with the occupant.

(First Modification of First Embodiment)

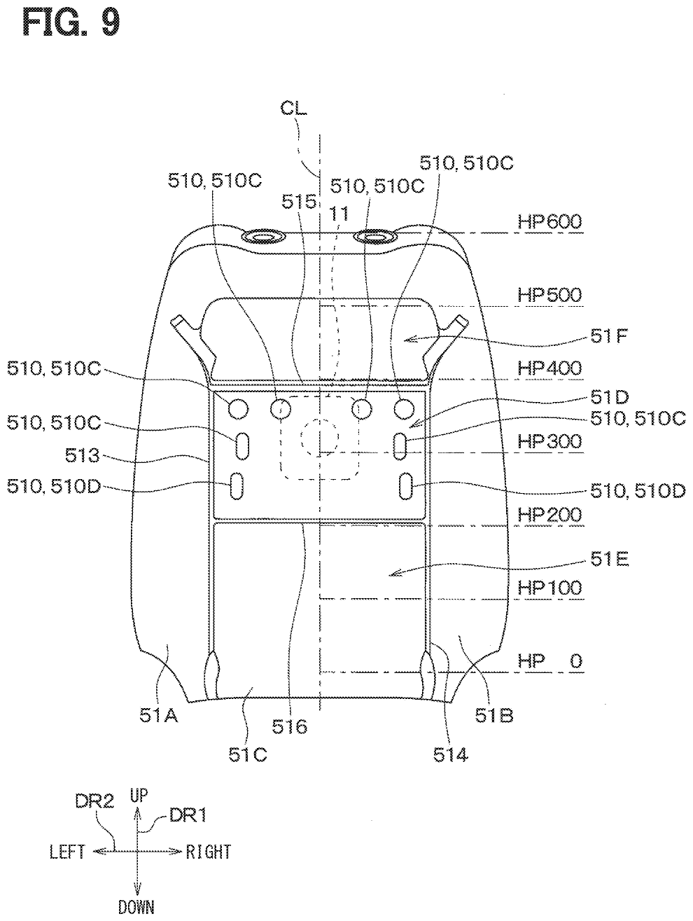

In the above-mentioned first embodiment, the ventilation holes 510 are defined at the portion of the back pad 51 in the range between HP100 to HP200, but the positions of the ventilation holes 510 are not limited to this. For example, as shown in FIG. 9, the ventilation holes 510 may be defined concentrated in the portion of the back pad 51 within the range between HP200 and HP400. Specifically, the ventilation holes 510 are defined in the thoracic spine corresponding portion 51D of the back pad 51 that corresponds to the third back portion P3 and the fourth back portion P4. The ventilation holes 510 are not defined in regions other than the thoracic spine corresponding portion 51D. In other words, the ventilation holes 510 are defined in the thoracic spine corresponding portion 51D that corresponds to a region of the body of the dummy DP below the shoulders and above the lower back. The ventilation holes 510 are not defined in regions other than the thoracic spine corresponding portion 51D.

In particular, since the positions of the plurality of ventilation holes 510 are limited in the thoracic spine corresponding portion 51D in the seat air-conditioner 10 of the present embodiment, the occupant seated on the seat 1 is provided with comfort, and energy loss can be significantly suppressed.

(Second Modification of First Embodiment)

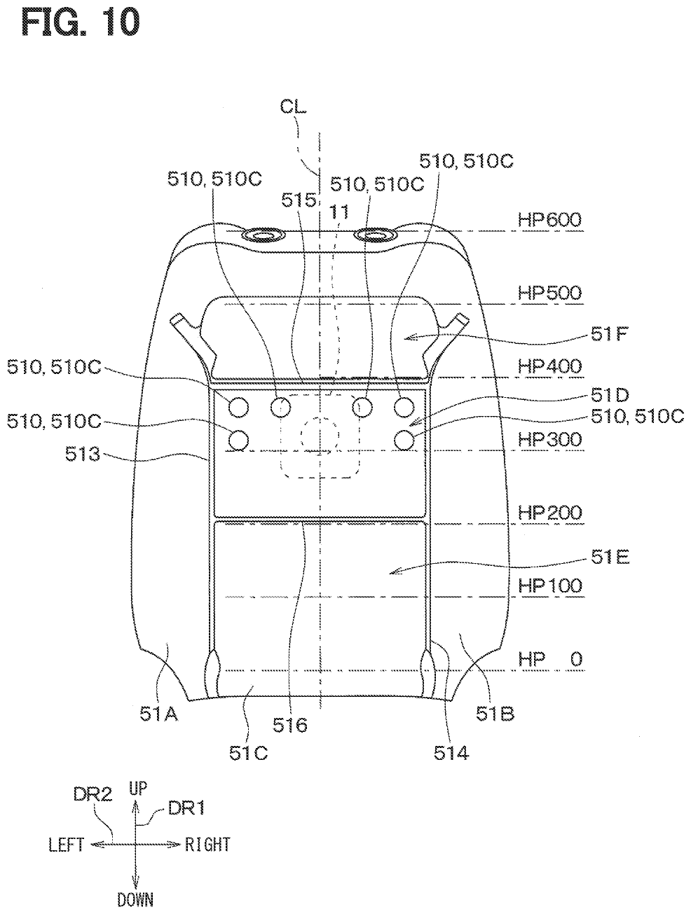

In the above-mentioned first modification, the ventilation holes 510 are formed in each of the third back portion P3 and the fourth back portion P4, but the positions of the ventilation holes 510 are not limited to this. For example, as shown in FIG. 10, the ventilation holes 510 may be defined only in the fourth back portion P4. According to this, since the positions of the plurality of ventilation holes 510 are limited in the fourth back portion P4 of the thoracic spine corresponding portion 51D, the occupant seated on the seat is provided with comfort and energy loss can be significantly suppressed.

(Other Modifications of First Embodiment)

In the above-mentioned first embodiment, the plurality of ventilation holes 510 are defined in the center portion 51C and not defined in the side portions 51A and 51 B. However, the positions of the ventilation holes 510 are not limited to this. For example, at least one of the ventilation holes 510 may be defined in the side portions 51A and 51B.

In the above-mentioned first embodiment, the air suction position in the seat back 5 is biased by biasing the positions of the ventilation holes 510, but the seat back 5 is not limited to this. For example, the seat back 5 may have a structure in which the ventilation resistance in the ventilation passage 511 is smaller in the upper back portion PA than in the lower back portion PB so that the sucked amount of air is biased toward the upper back portion PA.

In the above-mentioned first embodiment, as the introducing passage of the seat 1, the amount of air sucked into the seat 1 decreases in the order of the upper back portion PA, the lower back portion PB, and the seat cushion 2. However, the introducing passage of the seat 1 is not limited to this. For example, the introducing passage of the seat 1 may be configured so that the sucked amount of air is equal between the upper back portion PA and the lower back portion PB.

In the above-mentioned first embodiment, the blower 11 is disposed in the upper back portion PA, but the position of the blower 11 is not limited to this. The blower 11 may be provided, for example, in the lower back portion PB.

In the above-mentioned first embodiment, the seams of the skin 52 are accommodated in the vertical suspension grooves 513 and 514 and the horizontal suspension grooves 515 and 516 of the back pad 51, but the seat back 5 is not limited to this structure. In the seat back 5, for example, the skin 52 and the back pad 51 may be integrally formed with each other by foaming a material same as the back pad 51 inside the skin 52. This also applies to the seat cushion 2.

### Second Embodiment

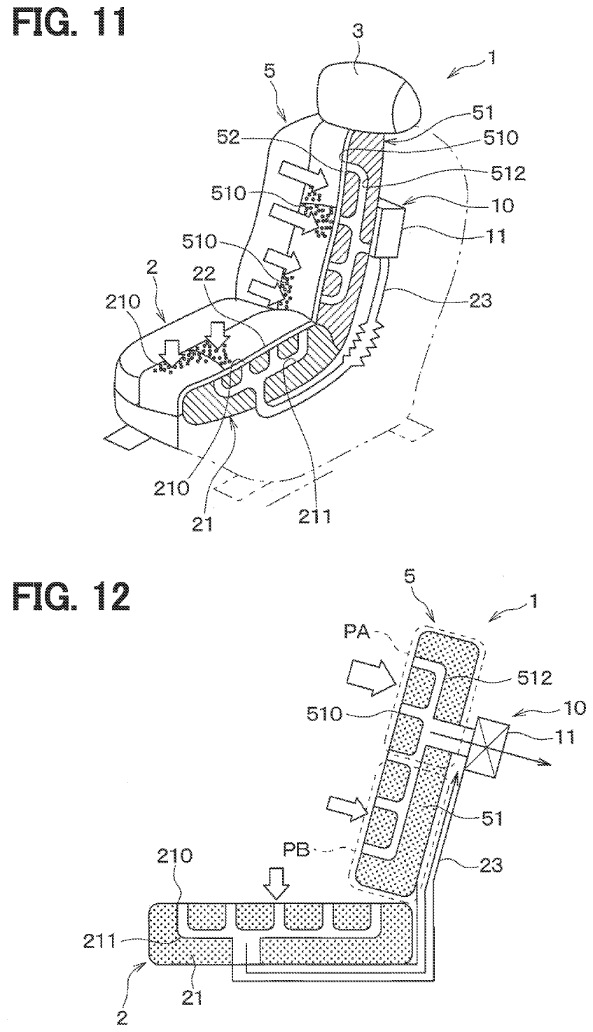

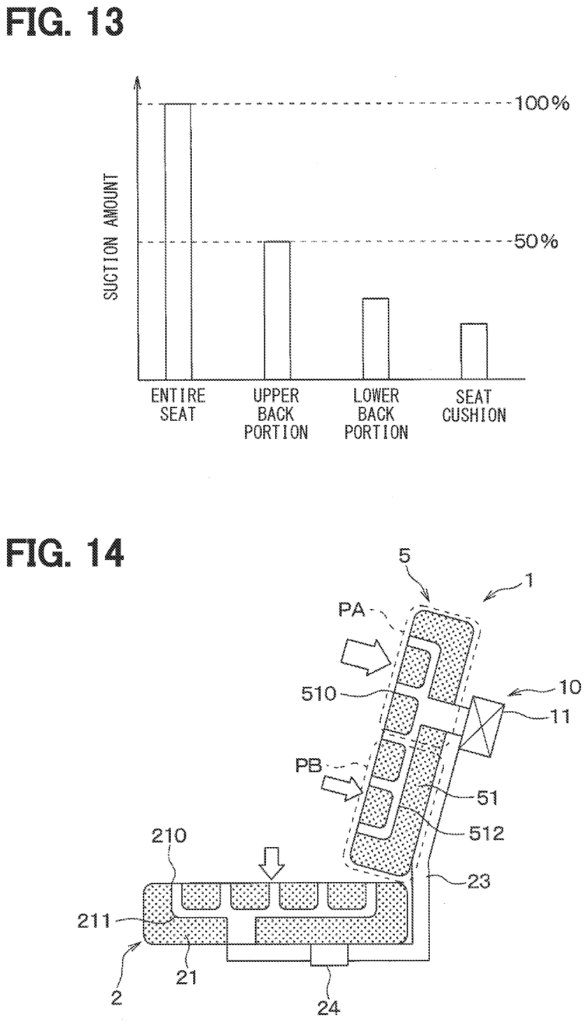

Next, a second embodiment will be described with reference to FIGS. 11 to 13. In the present embodiment, differences from the first embodiment will be mainly described.

As shown in FIGS. 11 and 12, the seat cushion 2 has the cushion pad 21, the skin 22 and the like. The front surface of the cushion pad 21 defines a plurality of first ventilation holes 210 through which the airflow generated by the blower 11 passes. In the back poriton of the cushion pad 21, a first ventilation passage 211 fluidly connected to the first ventilation holes 210 is defined.

The front surface of the seat back 5 defines a plurality of second ventilation holes 510 through which airflow generated by the blower 11 passes. The number of the second ventilation holes 510 defined in the upper back portion PA is larger than that in the lower back portion PB so that the amount of air sucked into the seat back 5 is larger in the upper back portion PA.

Further, in the back portion of the back pad 51, a second ventilation passage 512 fluidly connected to the second ventilation holes 510 is defined. The second ventilation passage 512 is fluidly connected to the blower 11 via a manifold (not shown).

Here, the first ventilation passage 211 is fluidly connected to the second ventilation passage 512 via a connecting duct 23. The connecting duct 23 is a member separately formed from the back pad 51 and the cushion pad 21, and is arranged behind the back pad 51 and the cushion pad 21. One end of the connecting duct 23 is fluidly connected to the first ventilation passage 211, and the other end of the connecting duct 23 is fluidly connected to the second ventilation passage 512. In the present embodiment, the first ventilation passage 211, the second ventilation passage 512, and the connecting duct 23 form an introducing passage through which air is introduced from the supporting surface of the seat 1 to the blower 11.

The airflow sucked through the seat cushion 2 flows through the first ventilation passage 211 and the connecting duct 23 in this order. Therefore, the introducing passage for the seat cushion 2 is formed of the first ventilation passage 211 and the connecting duct 23.

On the other hand, the airflow sucked through the seat back 5 flows to the blower 11 through the second ventilation passage 512 without flowing through the connecting duct 23. Therefore, a passage from the supporting surface of the seat back 5 to the blower 11 is shorter than a passage from the supporting surface of the seat cushion 2 to the blower 11. Since the length of the introducing passage for the seat back 5 is shorter than the length of the introducing passage for the seat cushion 2, the ventilation resistance is smaller in the introducing passage for the seat back 5 than in the introducing passage for the seat cushion 2.

As a result, the introducing passage of the seat 1 in this embodiment is configured such that the amount of air sucked into the seat 1 decreases in the order of the upper back portion PA, the lower back portion PB, and the seat cushion 2. Further, in the introducing passage of the seat 1, the ratio of the amount of air sucked through the upper back portion PA to the total amount of air sucked through the seat 1 is about 50% and the ratio of the amount of air sucked through the lower back portion PB to the total amount of air sucked through the seat 1 is about 30%. According to the introducing passage of the seat 1 in this embodiment, the ratio of the amount of air sucked through the seat back 5 to the total amount of air sucked through the seat 1 exceeds 50%.

The other configurations are the same as those of the first embodiment. The seat air-conditioner 10 in the present embodiment can achieve the advantages obtained from the common configuration or the equivalent configuration to the first embodiment.

In particular, the introducing passage of the seat 1 of the present embodiment includes the first ventilation passage 211 defined in the seat cushion 2, the second ventilation passage 512 defined in the seat back 5 and fluidly connected to the blower 11, and the connecting duct fluidly connecting the first ventilation passage 211 to the second ventilation passage 512.

According to this, the first ventilation passage 211 is connected to the blower 11 through the connecting duct 23, unlike the second ventilation passage 512. Therefore, the airflow generated by the blower 11 tends to flow more through the seat back 5 than through the seat cushion 2.

As described above, even when the seat air-conditioner 10 of the present embodiment includes the single blower 11, the airflow generated by the blower 11 can disproportionally flow through the seat back 5 than through the seat cushion 2 according to the structure of the seat 1.

Here, the introducing passage of the seat 1 is configured so that the amount of air sucked into the seat 1 decreases in the order of the upper back portion PA, the lower back portion PB, and the seat cushion 2. According to this, it is possible to efficiently provide the occupant with comfort as in the first embodiment.

(Modification of Second Embodiment)

In the second embodiment described above, the introducing passage of the seat 1 is described to have a structure in which the amount of air sucked into the seat 1 decreases in the order of the upper back portion PA, the lower back portion PB and the seat cushion 2. However, the introducing passage of the seat 1 is not limited to this. In the introducing passage of the seat 1, the amount of sucked air through the upper back portion PA may be equal to the amount of air through the lower back portion PB, or the amount of sucked air through the lower back portion PB may be equal to the amount of sucked air through the seat cushion 2.

### Third Embodiment

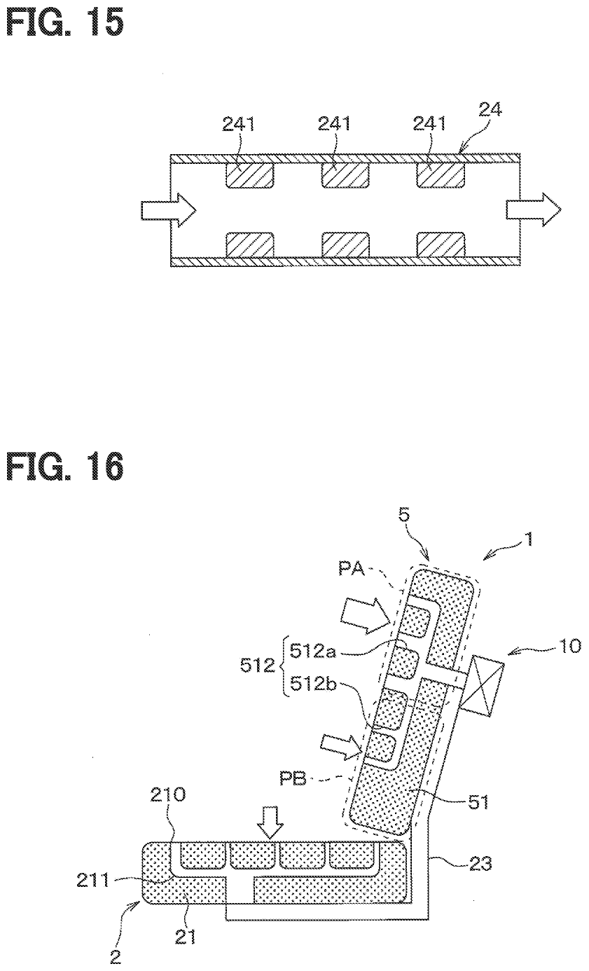

Next, a third embodiment will be described with reference to FIGS. 14 and 15. In the present embodiment, differences from the second embodiment will be mainly described.

As shown in FIG. 14, the connecting duct 23 has a resistance portion 24 that gives a ventilation resistance on the airflow flowing through the connecting duct 23 from the first ventilation passage 211. The resistance portion 24 increases the ventilation resistance of the introducing passage for the seat cushion 2 to be larger than the ventilation resistance of the introducing passage for the seat back 5.

As shown in FIG. 15, the resistance portion 24 is formed of throttle portions 241 that narrow the passage inside the connecting duct 23. That is, the connecting duct 23 has portions having reduced passage cross-sectional areas due to the resistance portions 24.

The other configurations are similar to those of the second embodiment. The seat air-conditioner 10 in the present embodiment can achieve the advantages obtained from the common configuration or the equivalent configuration to the second embodiment.

In particular, the connecting duct 23 of the present embodiment has the resistance portion 24 that gives a ventilation resistance on the airflow flowing through the connecting duct 23. According to this, the airflow generated by the blower 11 flows more through the second ventilation passage 512 than through the first ventilation passage 211. Therefore, the airflow generated by the blower 11 can flow disproportionally through the seat back 5 than through the seat cushion 2.

(Modification of Third Embodiment)

In the third embodiment described above, the resistance portion 24 of the connecting duct 23 is formed of the throttle portions 241. However, the resistance portion 24 is not limited to this. The resistance portion 24 may be formed of a meandering portion that increases the passage length.

### Fourth Embodiment

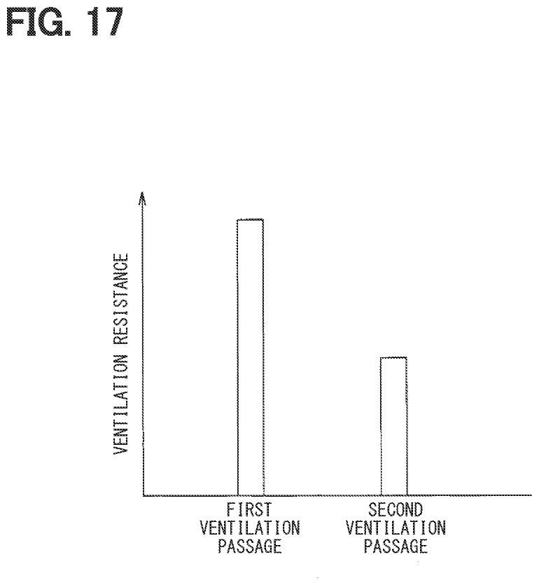

Next, a fourth embodiment will be described with reference to FIGS. 16 and 17. In the present embodiment, differences from the second embodiment will be mainly described.

As shown in FIG. 16, the passage cross-sectional area of the first ventilation passage 211 is smaller than that of the second ventilation passage 512. The passage cross-sectional area of the first ventilation passage 211 is, for example, about half the passage cross-sectional area of the second ventilation passage 512. As a result, as shown in FIG. 17, the first ventilation passage 211 is configured to have a larger ventilation resistance than the second ventilation passage 512.

Further, the second ventilation passage 512 has a lower ventilation passage 512b formed in the lower back portion PB and an upper ventilation passage 512a formed in the upper back portion PA. The lower ventilation passage 512b has a smaller passage cross-sectional area than the upper ventilation passage 512a. That is, the passage cross-sectional area of the introducing passage of the seat 1 decreases in the order of the upper back portion PA, the lower back portion PB and the seat cushion 2. As a result, the introducing passage of the seat 1 is configured such that the amount of air sucked into the seat 1 decreases in the order of the upper back portion PA, the lower back portion PB and the seat cushion 2.

The other configurations are similar to those of the second embodiment. The seat air-conditioner 10 in the present embodiment can achieve the advantages obtained from the common configuration or the equivalent configuration to the second embodiment.

In particular, the first ventilation passage 211 of the present embodiment is configured to have a larger ventilation resistance than the second ventilation passage 512. According to this, the airflow generated by the blower 11 flows more through the second ventilation passage 512 than through the first ventilation passage 211. Therefore, the airflow generated by the blower 11 can flow disproportionally through the seat back 5 than through the seat cushion 2.

(Modification of Fourth Embodiment)

The introducing passage of the seat 1 is not limited to the one described in the fourth embodiment. For example, the introducing passage may be configured such that the first introducing passage 211 has a smaller passage cross-sectional area than the second ventilation passage 512 and the connecting duct 23 has the resistance portion 24.

Further, in the seat air-conditioner 10, the skin 22 of the seat cushion 2 is made of a material having lower air permeability than the skin 52 of the seat back 5, so that the airflow flows disproportionally through the seat back 5 than through the seat cushion 2.

### Other Embodiments

Although the representative embodiments of the present disclosure have been described above, the present disclosure is not limited to the embodiments and can be variously modified as follows, for example.

In the above-described embodiments, the blower 11 is arranged only in the seat back 5, but the seat air-conditioner 10 is not limited to this. The blower 11 may be disposed in the seat cushion 2 when the seat air-conditioner 10 is configured such that airflow generated by the blower 11 flows more through the seat back 5 than through the seat cushion 2.

In the above-described embodiments, the seat 1 having the headrest 3 is exemplified, but the seat 1 may not have the headrest 3.

In the above-described embodiments, an example in which the seat air-conditioner 10 of the present disclosure is applied to the seat 1 installed in the vehicle has been described, but the application target of the seat air-conditioner 10 is not limited to this. The seat air-conditioner 10 can be widely applied to, for example, stationary seats used in theaters, home, and the like.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, the present disclosure is not limited to the shape, positional relationship, and the like, except for the case of being specifically specified, the case of being fundamentally limited to a specific shape, positional relationship, and the like, and the like.

(Overview)

According to the first aspect shown in a part or all of the above-described embodiments, a seat air-conditioner includes a blower configured to suck air through a supporting surface of a seat and an introducing passage through which the air is introduced from the supporting surface to the blower. The blower is disposed in the seat back such that airflow generated by the blower flows more through the seat back than through the seat cushion.

According to the second aspect, the introducing passage is configured such that a ratio of an amount of air sucked through the seat back to a total amount of air sucked into the seat is more than 50%. According to this, due to the structure of the introducing passage, the ventilation in the vicinity of the body portion of the occupant that is sensitive to cold is preferentially performed.

According to the third aspect, a portion of the seat back exposed to the occupant is equally divided an up-down direction into an upper back portion and a lower back portion, the introducing passage is configured such than an amount of air sucked into the seat decreases in the order of the upper back portion, the lower back portion and the seat cushion.

According to this, the ventilation capacity in the upper back portion of the seat back that corresponds to the shoulders and the thoracic spine where the cold spot density and the perspiration amount of the body are high is enhanced. In particular, the upper back portion has a lower sitting pressure in the seat back than the lower back portion corresponding to the lower back where the cold spot density and perspiration amount are high as in the shoulders and thoracic spine, and the airflow is less likely to be interfered. Thus, it is possible to efficiently provide the occupant with comfort.

According to the fourth aspect, the introducing passage is configured such that a ratio of an amount of air sucked through the upper back portion to the total amount of air sucked into the seat is equal to or more than 50%. According to this, the ventilation in the vicinity of the portion of the body of the occupant that is sensitive to cold and where airflow is less likely to be inhibited can be preferentially performed.

According to the fifth aspect, the blower is disposed to face the upper back portion in the seat back. According to this, since the blower is disposed to face the upper back portion where the suction amount of air is large, the portion of the introducing passage from the upper back portion to the blower is decreased and pressure loss in the portion is suppressed. Thus, efficient air conditioning can be achieved with reduced pressure loss in the portion of the introducing passage.

According to the sixth aspect, the introducing passage is defined in the seat back and is not defined in the seat cushion. According to this, since a configuration for sucking air from the seat cushion is not required, the seat air-conditioner can be realized with a simple configuration.

According to the seventh aspect, the introducing passage includes a first ventilation passage defined in the seat cushion, a second ventilation passage defined in the seat back and fluidly connected to a blower, and a connecting duct fluidly connecting the first ventilation passage to the second ventilation passage. Unlike the second ventilation passage, the connecting duct is interposed between the first ventilation passage and the blower. Therefore, the airflow generated by the blower is more likely to flow through the seat back than through the seat cushion.

According to the eighth aspect, the connecting duct includes a resistance portion that gives a ventilation resistance on airflow flowing through the connecting duct. According to this, the airflow generated by the blower is more likely to flow through the second ventilation passage than through the first ventilation passage. Therefore, the airflow generated by the blower can disproportionally flow through the seat back than through the seat cushion. The “ventilation resistance” is a pressure loss that occurs when airflow flows through a passage.

According to the ninth aspect, the first ventilation passage has a ventilation resistance greater than that of the second ventilation passage. According to this, the airflow generated by the blower is more likely to flow through the second ventilation passage than through the first ventilation passage. Therefore, the airflow generated by the blower can disproportionally flow through the seat back than through the seat cushion.

What is claimed is:

1. A seat air-conditioner applied for a seat on which an occupant is seated, the seat air-conditioner comprising:
a blower configured to suck air through a supporting surface of the seat that supports the occupant; and
an introducing passage through which the air is introduced from the supporting surface to the blower, wherein
the seat includes a seat cushion supporting a lower body of the occupant and a seat back supporting an upper body of the occupant, and
the blower is disposed in the seat back such that airflow generated by the blower flows more through the seat back than through the seat cushion.

2. The seat air-conditioner according to claim 1, wherein
the introducing passage is configured such that a ratio of an amount of air sucked through the seat back to a total amount of air sucked into the seat is more than 50%.

3. The seat air-conditioner according to claim 1, wherein
a portion of the seat back exposed to the occupant is equally divided in an up-down direction into an upper back portion and a lower back portion, and
the introducing passage is configured such that an amount of air sucked into the seat decreases in the order of the upper back portion, the lower back portion and the seat cushion.

4. The seat air-conditioner according to claim 3, wherein
the introducing passage is configured such that a ratio of an amount of air sucked through the upper back portion to the total amount of air sucked into the seat is equal to or more than 50%.

5. The seat air-conditioner according to claim 3, wherein
the blower is disposed to face the upper back portion in the seat back.

6. The seat air-conditioner according to claim 1, wherein
the introducing passage is defined in the seat back and is not defined in the seat cushion.

7. The seat air-conditioner according to claim 1, wherein
the introducing passage includes:
a first ventilation passage defined in the seat cushion;
a second ventilation passage defined in the seat back and fluidly connected to the blower; and
a connecting duct fluidly connecting the first ventilation passage to the second ventilation passage.

8. The seat air-conditioner according to claim 7, wherein
the connecting duct includes a resistance portion that gives a ventilation resistance on airflow flowing through the connecting duct.

9. The seat air-conditioner according to claim 7, wherein
the first ventilation passage has a ventilation resistance greater than that of the second ventilation passage.
